(19) United States
(12) Patent Application Publication
(10) Pub. No.: US 2006/0072610 A1
(43) Pub. Date: Apr. 6, 2006

(54) Receiver, transmitter, method and systems for processing a network data unit in the network stack

(75) Inventors: Sandrine Merigeault, Paris (FR); Catherine Lamy, Paris (FR); Nicolas Vanhaelewyn, Suresnes (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/534,073

(22) PCT Filed: Oct. 29, 2003
(86) PCT No.: PCT/IB03/04832

§ 371 Date: May 6, 2005

(30) Foreign Application Priority Data
Nov. 8, 2002 (FR) 02/14035

(51) Int. Cl. H04J 3/16

(52) U.S. Cl. 370/469; 370/474

(57) ABSTRACT

The invention relates to a receiver (REC) comprising means for using a network stack (PR) intended to process a data unit (UDR) received via a network (R), means for establishing a direct connection (CD) between a departure layer (L₁) and an arrival layer (L₇) of said network stack, means (GENER) for generating local data (DL) at the level of said departure layer (L₁), said local data (DL) being intended to be transmitted to said arrival layer (L₇) via said direct connection (CD), means (PACKET) for packeting said local data (DL) into a data structure (SDL), and means (RETRIEV) for retrieving said local data (DL) at the level of said arrival layer (L₇).

### FIELD OF THE INVENTION

The invention relates to a transmission system, a transmitter for transmitting a data unit to a receiver via a network, and a receiver for processing a data unit received via a network.

The invention also relates to a method used by such a receiver or such a transmitter, and to a computer program using said method.

The invention notably finds its application in the field of transmitting and receiving multimedia data via a network having a limited passband and being liable to errors.

### BACKGROUND OF THE INVENTION

U.S. Pat. No. 6,246,683 B1 describes a method used by a receiver for processing a data unit received via a network. Said receiver 1, described in a functional manner with reference to FIG. 1a, comprises a network stack 2 and a direct connection 3 between a departure layer L₁ and an arrival layer L₇ of said network stack.

As is indicated in FIG. 1b, in a transmission system comprising a network managed by a network stack, a data unit UDR received by a receiver comprises control information IC, which is intended for said network stack, and useful information IU which is intended for a destination application DAPP. Said control information IC is intended for the successive layers of the network stack, which uses them for verifying the validity of the received data unit UDR. A layer Lᵢ, in which i is an integer equal to 1 . . . 7 in accordance with the reference model ISO which is well known to those skilled in the art, decides whether said data unit UDR is valid as a function of the control information ICᵢ concerning it. If this is the case, it transmits said data unit to the upper layer of said stack, after having relieved it from control information ICᵢ. If not, the data unit UDR is rejected. At the top of the network stack, the received data unit UDR only contains the useful information IU which is finally transmitted to said destination application DAPP. Consequently, only a data unit conforming to the protocols used by the network can traverse the stack 2.

Said receiver 1 described in the above-cited United States patent comprises, at the level of the departure layer L1, means for using a network interface IR, intended to separate the control information IC from the useful information IU within said data unit UDR. The control information IC is subsequently processed in the normal manner by the means for using the network stack 2, while the useful information IU is transmitted to the application layer L₇ via said direct connection 3.

Such a method has the advantage that the processing of a data unit UDR received by said receiver 1 in terms of using memory resources is optimized. The fact that the useful information IU is conveyed via said direct connection provides the possibility of avoiding a certain number of memory copies of said information which would necessitate their passage in the network stack 2.

### OBJECT AND SUMMARY OF THE INVENTION

It is an object of the invention to use such a direct connection between a departure layer and an arrival layer of a network stack for another purpose.

A receiver according to the invention as described in the opening paragraph is characterized in that it comprises:
means for using a network stack intended to process a data unit received via a network,
means for establishing a direct connection between a departure layer and an arrival layer of said network stack,
means for generating local data at the level of said departure layer, said local data being intended to be transmitted to said arrival layer via said direct connection,
means for packeting said local data into a data structure, and
means for retrieving said local data at the level of said arrival layer.

The invention allows the optimization, from a qualitative point of view, of processing a data unit received by said receiver by sending local data available at the level of said departure layer to said arrival layer.

Indeed, in the field of transmitting multimedia data, the networks used are networks having a limited passband and a high error rate, such as, for example, wireless networks. One means of correcting said errors is to send, to the application destination, i.e. to the application layer of the network stack, data which are locally available at the level of the receiver such as, for example, a transmission channel state at the moment of passage of said data unit or a probability that said data unit has errors. A major problem is that said local data must make use of the network stack so as to be transmitted to said application layer and must thus be packeted in a data unit in conformity with the protocols which govern said stack. This is a relatively complex operation necessitating detailed knowledge of said protocols.

The invention therefore proposes a simple solution for sending local data from a departure layer to an arrival layer in a network stack, with the aid of a direct connection between the two layers. This solution is advantageous because it does not require any previous knowledge of the protocols governing said stack.

Said direct connection may be an open connection, for example, by means of drivers or sockets which are placed at the level of the departure layer and the arrival layer of said stack.

It should be noted that the sockets mentioned here are of a particular type, very similar to those used in the field of information security for constructing firewalls.

As such a connection is open for sending a known type of local data from the departure layer to the arrival layer in the network stack, a minimum of control information is necessary to characterize such data. Packeting said local data and said control information in one and the same data structure is certainly necessary but said data structure is much reduced. The means to be used for packeting and subsequent unpacketing said data are thus very simple and consequently the transfer of said data from the departure layer to the arrival layer is realized very rapidly.

It should be noted that such a direct connection may a priori be open between two arbitrary layers of a network stack, particularly in the case of use with drivers. In contrast, if sockets are used, said connection can only be established between a lower layer (the physical layer or the connection layer) and the application layer of said stack.

Another advantage of this solution is that it is independent of the protocols governing the network stack. It is thus valid irrespective of the protocols used and suitable for any type of receiver, provided that it can establish a direct connection between two layers of a network stack. Moreover, such a solution does not affect the actual operation of said stack and consequently does not disturb it.

When the local data generated by the departure layer of the network stack relate to a data unit received by the receiver, the receiver according to the invention also comprises marking means intended to associate said local data with said received data unit, by adding a marker to them.

A possible marker is the relevant received data unit. The advantage of such a marker is that the independence of the solution with respect to the protocols used by the network stack is preserved.

In a first embodiment, said generated local data relate to the state of the channel. Such data may be helpful for the destination application in deciding whether erroneous received data must be corrected or whether retransmission to the transmitter is required.

In a second embodiment, said local data relate to probabilities that the received data are erroneous. Such probabilities may be helpful for the destination application in marking the erroneous received data in order to process them accordingly.

The invention also relates to a transmitter for processing data to be transmitted to a receiver via a network. Said transmitter comprises means for using a network stack and means for establishing a direct connection between a departure layer, for example, an upper layer, and an arrival layer, for example, a lower layer, of said stack.

In a third embodiment, said departure layer provides local data indicating an importance of the data to be transmitted to the receiver via the network. Such data may be advantageously used by a channel encoder for protecting the data to be transmitted in a differential manner. A second advantage is that, by further protecting the most important data to be transmitted, there is a smaller risk that these data are lost and, consequently, the number of retransmissions required by the receiver in the case of erroneous data units is limited. The use of the passband of the network is thus optimized.

### BRIEF DESCRIPTION OF THE DRAWINGS

These aspects of the invention as well as other, more detailed aspects will be more clearly apparent from the following description of several embodiments of the invention, given by way of non-limiting examples, and with reference to the accompanying drawings in which:

FIG. 1a is a functional diagram of a receiver comprising means for using a network stack and means for direct connection between a departure layer and an arrival layer of said stack, in accordance with the prior art,

FIG. 1b describes the structure of a data unit intended to be transmitted via a network, in accordance with the prior art,

FIG. 2 describes, in a functional manner, a data transmission system comprising a transmitter, a network and a receiver according to the invention,

FIG. 3 is a functional diagram of a receiver according to the invention, comprising means for using a network stack and means for establishing a direct connection between a departure layer and an arrival layer of said stack, said connection being intended to transmit a local data describing the state of the transmission channel from the departure layer to the arrival layer,

FIG. 4 shows a data structure marked in accordance with the invention,

FIG. 5 is a functional diagram of means for retrieving local data used at the level of the arrival layer of the direct connection according to the invention,

FIG. 6 is a functional diagram of means for generating, packeting and marking local data at the level of the departure layer of the direct connection, while said local data are formed from flexible data supplied by a channel decoder,

FIG. 7 describes the structures of a data unit and of local data associated therewith, in the case where said local data are constituted by said flexible data,

FIG. 8 is a functional diagram of a transmitter according to the invention, comprising means for using a network stack and means for establishing a direct connection between a departure layer and an arrival layer of said stack,

FIG. 9 is an example of the local data structure marked in the case where the local data indicate a degree of importance of data transmitted by an application source.

### DESCRIPTION OF EMBODIMENTS

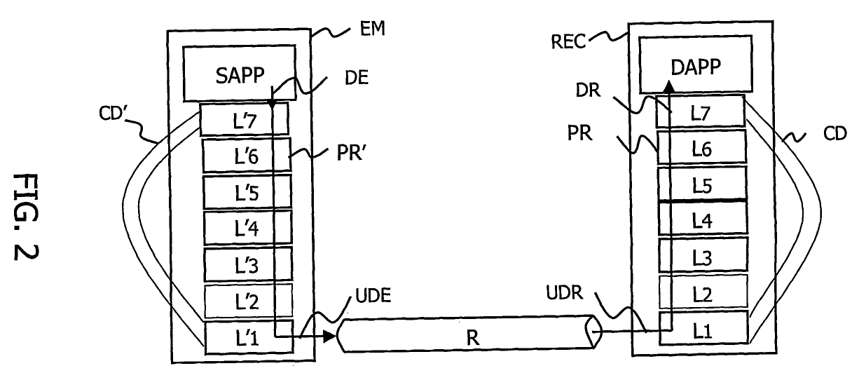

FIG. 2 describes, in a functional manner, a transmission system according to the invention, comprising a transmitter EM, a network R and a receiver REC. Said receiver REC comprises a network stack PR and a direct connection CD between a departure layer L₁ and an arrival layer L₇ of said stack. Said transmitter EM comprises a network stack PR′ and a direct connection CD′ between a departure layer L′₇ and an arrival layer L′₁ of said stack.

Data DE are transmitted by a source application SAPP of said transmitter EM and then processed by said stack PR′. A data unit UDE is transmitted through the transmission channel of the network R. A data unit UDR is received by the network stack PR of said receiver REC. Received data DR are supplied to a destination application DAPP.

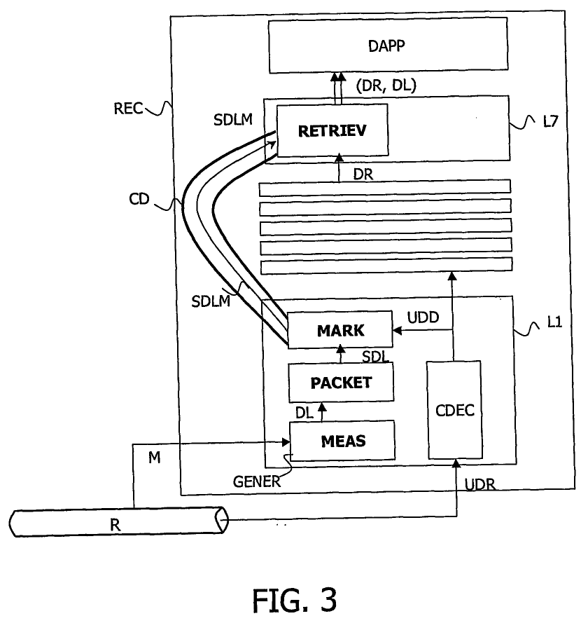

In a first embodiment of the invention, the receiver REC shown in FIG. 3 is considered. Said data unit UDR is received by the physical layer L₁. It is first processed by a channel decoder CDEC which supplies a decoded data unit UDD. Let us consider local data DL, created at the level of the physical layer L₁ by generating means GENER and to be transmitted to the application layer L₇. In the first embodiment of the invention, the state EC of the transmission channel is concerned. Such information may be advantageously used by the destination application DAPP. Indeed, when certain data are not sent to said destination application because of transmission errors, the knowledge of the state of the channel allows a choice of two options:
if the channel is in a mediocre state, retrieve the erroneous data where they have been blocked in the network stack PR₂ so as to attempt to correct the errors,
if, in contrast, the channel is in a good state, request the transmitter to retransmit missing data.

In this first embodiment, the generating means GENER comprise sub-means MEAS for measuring the state of the channel EC, which means measure a data M and transform it into local data DL describing the state of the channel EC. It concerns, for example, an error rate.

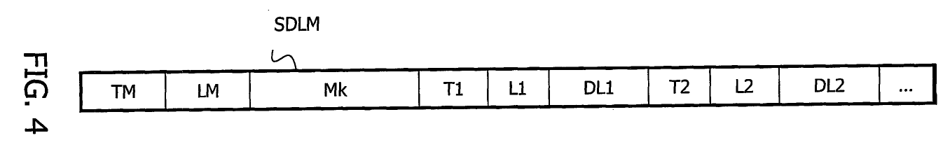

Said local data DL (EC in the example of the state of the transmission channel) are subsequently processed by packeting means PACKET intended to packet said local data in order to render them usable by the arrival layer L₇ which will receive them via the direct connection CD. Said packeting means PACKET supply a data structure SDL which is, for example, organized in the way as shown in FIG. 4. Such a structure minimally comprises three fields:
a first field describing a type of local data Tᵢ, in which i is an integer between 1 and the total number of local data types,
a second field describing a length of the local data Lᵢ, in which i is an integer between 1 and the total number of local data types, and
a third field comprising the relevant local data DLᵢ.

These three fields are sufficient when the local data DL to be transmitted are not associated with any data unit UDE transmitted by the transmitter EM and sent to the destination application DAPP by the network stack. This may be the case for the state of the channel EC. One may then consider that the local data received by the destination application DAPP are valid until the next update.

Such a structure SDL also allows simultaneous transmission of several local data of different types to the destination application DAPP by concatenating them within one and the same structure.

In contrast, if the local data concern a particular received data unit UDR, said packeting means PACKET also comprise means MARK for marking said local data structure SDL, intended to mark said structure by means of a field Mk, which is characteristic of said data unit UDR.

For example, the state of the channel EC is a local data which varies in time and, by virtue thereof, the validity of a measure of the state of the channel is generally limited to the transmission of a data or a series of data. In the case where a marking of said structure SDL is necessary, three supplementary fields are used, as is shown in FIG. 4:
a type TM of the marker Mₖ,
a length LM of the marker Mₖ, and
the marker Mₖ itself.

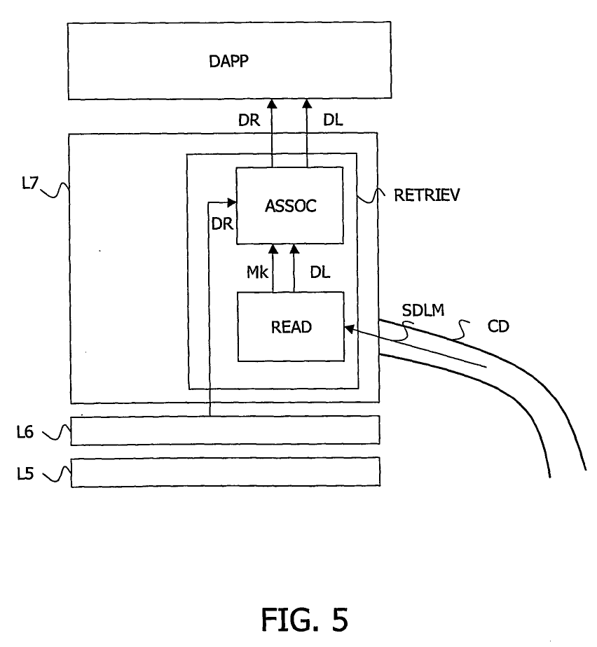

A marked data structure SDLM is then supplied to the direct connection CD. The marked data structure SDLM is subsequently sent to the arrival layer, in this case the application layer L₇ via said direct connection CD. Said layer L₇ comprises retrieving means RETRIEV, shown in FIG. 5, for retrieving the local data DL within said marked data structure SDLM.

Said retrieving means RETRIEV are very simple in the case where the local data to be retrieved are independent, i.e. where they are not associated with any received data DR from the network stack PR. It is then sufficient to know the organization of the fields of the local data structure SDL so as to be able to read it. The retrieving means RETRIEV are thus essentially reduced to sub-means READ for reading said data structure SDL, intended to identify the relevant local data DL in the structure SDL.

In contrast, in the case where the local data to be retrieved relate to a received data unit UDR, said read sub-means READ do not only isolate the local data DL but also the marker Mₖ. Moreover, said retrieving means RETRIEV also comprise associating sub-means ASSOC intended to search with which received data DR said local data are associated. Such sub-means try, for example, to find a common data in the marker Mₖ and in the received data DR.

The choice of the marker Mₖ may be related to control information IC contained in the decoded data unit UDD and characteristic of said data unit UDD such as, for example, a sequence number. However, such a choice would require knowledge of the protocols used by the network stack PR. If, in contrast, one chooses the marker Mₖ to be equal to the decoded data unit UDD in question, no knowledge of the protocols is required. Indeed, since said marker contains a copy of said received data DR, the association of local data with decoded data will be evident. In this case, the associating sub-means ASSOC of the application layer L₇ easily associate the local data structure SDLM with the corresponding received data DR by means of a simple correlation measure.

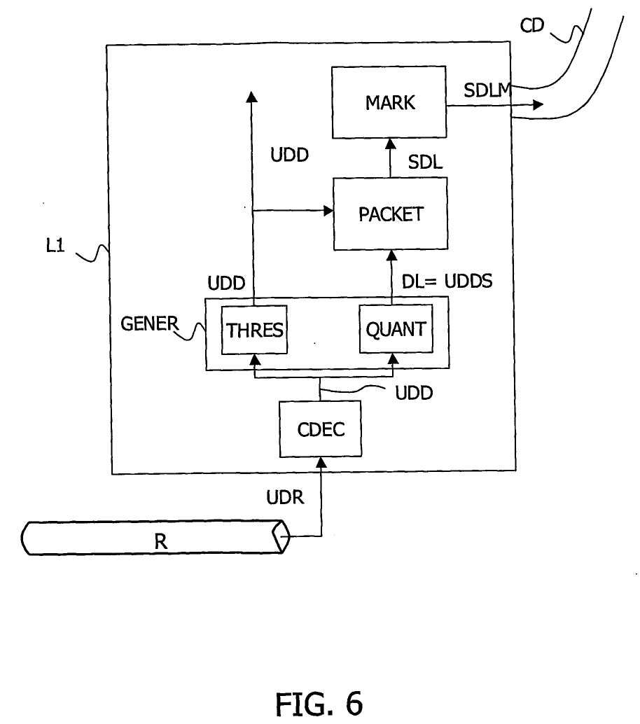

In the preferred embodiment shown in FIG. 6, the direct connection CD connects the physical layer L₁ to the application layer L₇, but this time the local data DL to be transmitted are very strongly associated with the received data units UDR.

At the level of the physical layer L₁, a channel decoder CDEC supplies, for a received data unit UDR, a real signal which is constituted by a succession of real data. Said signal may be processed in two different manners:
the first is to threshold each real data constituting said real signal by way of thresholding means THRES so to assign a binary value to it. In this case, we speak of a channel decoder having a hard output, and the succession of said binary values forms the decoded data unit UDD,
the second is to cause a quantized version of said real data to correspond to each real data, i.e. to quantize it at a limited number of bits with the aid of quantizing means QUANT. In this case, we speak of a channel decoder having a flexible output. The first bit, referred to as hard bit, is the same as that supplied by the thresholding means, while the subsequent bits provide a probability that the hard bit is correct. The succession of said probabilities forms a flexible decoded data unit UDDS.

In the case of a transmission network having a high error rate, the knowledge of such probabilities is very advantageous at all levels of the receiver and particularly at the level of the destination application DAPP. Indeed, such knowledge allows a more precise interpretation of a received data DR and facilitates a possible correction of errors. In contrast, from a point of view of the network stack PR, these probabilities cannot form part of the decoded data unit UDD transmitted by the physical layer L′₁ to the upper layers of the network stack. Indeed, a layer protocol of the network stack PR will not accept a flexible decoded data unit UDDS comprising a number of bits which is different from that of the transmitted data unit which has traversed the corresponding layer of the network stack PR. Said probabilities must thus be considered as local data generated by the generating means GENER situated at the level of the physical layer L₁. Said generating means GENER comprise thresholding sub-means THRES and quantizing sub-means QUANT using techniques which are well known to those skilled in the art.

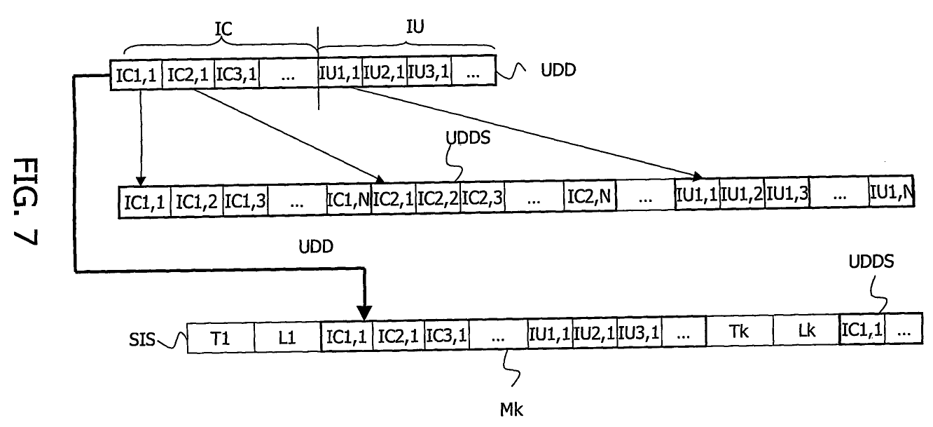

FIG. 7 shows a decoded data unit UDD, constituted by hard bits supplied by the thresholding sub-means THRES and a flexible decoded data unit UDDS supplied by the quantizing sub-means QUANT. It should be noted that said flexible decoded data unit UDDS comprises all the hard bits constituting the decoded data unit and quantization bits.

The packeting means PACKET subsequently supply a local data structure SDL which is also shown in FIG. 7.

As has been explained hereinbefore, the marker Mₖ used for marking the local data structure SDL containing the flexible bits associated with the hard bits of the received data DR is the decoded data unit itself in the preferred embodiment. An advantage of such a solution is that it is independent of protocols used and that it facilitates the assignment of local data to received data.

Nevertheless, it should be noted that, in the preferred embodiment, the invention is not completely independent of the protocols for the network stack PR. However, only the knowledge of a type of control information used in the majority of network stack models is required. It concerns control information used by at least one layer protocol of the network stack, namely the UDP protocol of the transport layer L₄, referred to as “checksum”. Said checksum has a value which is equal to the sum of the bits forming a data unit transmitted during its passage in the corresponding layer L₃ of the network stack PR′ and before it is sent on the network. At the receiving end, the corresponding layer of the network stack PR computes a new sum from the decoded data unit UDD. If it obtains a value which is identical to the checksum figuring in the control information of the data unit, said data unit UDD is declared valid by said layer. In the opposite case, it is rejected.

It is precisely for improving the performance of the receiver by correcting transmission errors that one wishes to transmit flexible data to the destination application DAPP. Therefore, the erroneous decoded data units should not be blocked at the level of the network stack PR₂ so as to give them an opportunity to be corrected by the destination application with the aid of local data DL supplied via the direct connection.

Consequently, in the preferred embodiment, the computation of the checksum UDP is inhibited, such that the decoded data units UDD which have been declared erroneous in accordance with this criterion are not rejected. The preferred embodiment of the invention which has been described hereinbefore thus punctually intervenes in the operation of the network stack and for this purpose requires the knowledge of a single type of widely used control information.

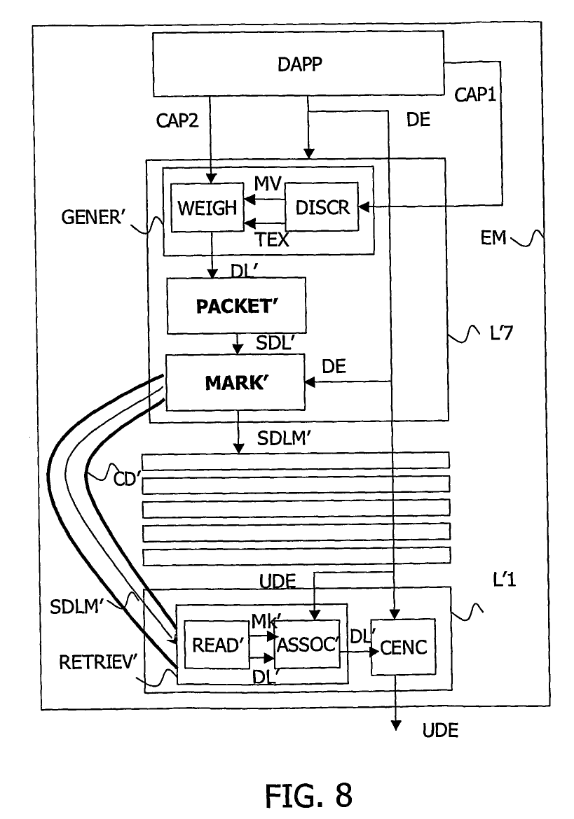

A third embodiment of the invention, illustrated in FIG. 8, refers to a transmitter comprising a source application SAPP, a network stack PR′ and a direct connection CD′ connecting the application layer L′₇ to the physical layer L′, of said stack. The source application SAPP supplies transmitted data DE to said stack PR′. The application layer L′₇ comprises means GENER′ for generating local data DL′ destined for the channel encoder CENC of the physical layer L′₁ in order to apply, for example, an unequal error protection (UEP) of the transmitted data DE. To this end, said generating means GENER′ comprise sub-means DISCR for discriminating types of data in said data DE on the basis of a priori knowledge (CAP1, CAP2) supplied by the source application SAPP. Let us consider, for example, a source application SAPP realizing a video source encoding by means of a standard of the MPEG type (Motion Picture Expert Group). In this case, the sub-means DISCR should recognize data of the “motion” type MV and of the “texture” type TEX. The a priori knowledge CAP₁ is related, for example, to the fact that the motion data MV are vectors while the texture data TEX are transform coefficients of the DCT type (Discrete Cosine Transform).

The generating means GENER′ also comprise weighting sub-means WEIGHT intended to weight the importance of the types of data discriminated on the basis of the a priori knowledge CAP₂. In the previous example of an encoder of a sequence of images of the MEPG video type, one may consider that the data of the motion type MV are more important than the data of the texture type TEX. Indeed, an encoding scheme of the MPEG type realizes a motion compensation of a current image with respect to a preceding image. Only a difference of texture between the current image and the preceding image which is motion-compensated is transmitted to the destination application DAPP. Consequently, without these motion data, the destination application DAPP, namely the source decoder, would not be able to reconstruct an acceptable current image from texture data only, whereas the contrary is possible. Consequently, by supplying this type of local data to the channel encoder CENC, it is given the means for performing an unequal error protection of the data adapted to the types of transmitted data.

The application layer L′₇ also comprises packeting means PACKET′ intended to structure the local data DL′ supplied by said generating means GENER′.

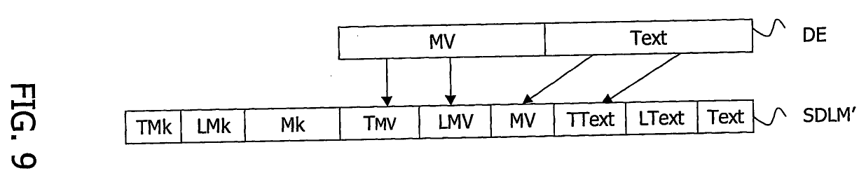

FIG. 9 shows a structure of local data SDL′ which are of a type TMV and a length LMV for a type of data discriminated in the transmitted data DE, for example, motion data MV. Such data are, by definition, associated with a transmitted data DE. Consequently, the application layer L′₇ also comprises marking means MARK′ intended to associate the data structure SDL′ with the transmitted data DE to which it relates. Said marking means MARK′ supply a marked data structure SDLM′ comprising a marker Mₖ′, a type T_{Mk} and a length L_{Mk}. Said marker Mₖ′ may be chosen to be equal to the transmitted data so as to be independent of the knowledge of the protocols used by the network stack PR′.

The physical layer comprises retrieving means RETRIEV′, intended to retrieve the local data DL′ within said structure SDLM′. Said retrieving means RETRIEV comprise sub-means READ′ for reading the structure SDLM′, intended to extract the local data DL′ and the marker Mₖ′, and sub-means ASSOC′ for associating said marker Mₖ′ with a transmitted data unit UDE, intended to retrieve the marker Mₖ′ within said transmitted data unit UDE. In a manner analogous to the embodiments of the invention described hereinbefore, this operation will be very simple in the case where said marker is chosen to be equal to the transmitted data.

The invention is not limited to the embodiments which have been described by way of example. These embodiments may be modified or improved without departing from the scope of the invention.

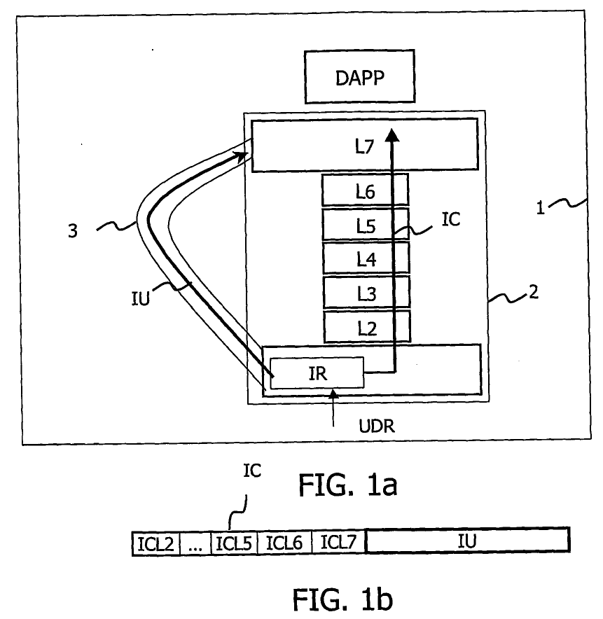

The description above with reference to FIGS. 1 to 9 illustrates rather than limits the invention. It will be evident that there are other alternatives which can be used without departing from the scope of the appendant claims.

There are numerous ways of implementing the functions described by means of software. In this respect, FIGS. 1 to 9 are very diagrammatic, each Figure only representing an embodiment. Although a Figure shows different functions in the form of separate blocks, this does not exclude that a single piece of software performs several functions. This neither excludes that a function can be performed by a software assembly.

It is possible to implement these functions by means of a receiver circuit comprising one or several suitably programmed processors. A set of instructions stored in a programming memory may cause the circuit to perform different operations described hereinbefore with reference to FIGS. 1 to 9. The set of instructions is, for example, loaded into the programming memory by reading a common data carrier, for example, a CD-ROM. In another embodiment, the reading may also be realized by means of a communication network such as the Internet. In this case, a service provider puts the set of instructions at the disposal of those interested.

Any reference sign between parentheses in a claim should not be construed as limiting the claim. Use of the verb “comprise” and its conjugations does not exclude the presence of elements or steps other than those stated in a claim. Use of the article “a” or “an” preceding an element or a step does not exclude the presence of a plurality of such elements or steps.

1. A receiver (REC) comprising:
means for using a network stack (PR) intended to process a data unit (UDR) received via a network (R),
means for establishing a direct connection (CD) between a departure layer (L₁) and an arrival layer (L₇) of said network stack,
means (GENER) for generating local data (DL) at the level of said departure layer (L₁), said local data being intended to be transmitted to said arrival layer (L₇) via said direct connection (CD),
means (PACKET) for packeting said local data (DL) into a data structure (SDL), and
means (RETRIEV) for retrieving said local data (DL) at the level of said arrival layer (L₇).

2. A receiver (REC) as claimed in claim 1, characterized in that it comprises marking means (MARK) intended to associate said data structure (SDL) with a received data unit (UDR) by adding a marker (Mₖ) to it.

3. A receiver (REC) as claimed in claim 2, characterized in that said marker (Mₖ) is chosen to be equal to said received data unit (UDR).

4. A method of processing a data unit (UDR) received via a network (R), intended to be used by a receiver (REC) comprising means for using a network stack (PR) and means for establishing a direct connection (CD) between a departure layer (L₁) and an arrival layer (L₇) of said network stack (PR), said method comprising the steps of:
generating (GENER) local data (DL) at the level of said departure layer (L₁), said local data (DL) being intended to be transmitted to said arrival layer (L₇) via said direct connection (CD),
packeting (PACKET) said local data (DL) into a data structure (SDL), and
retrieving (RETRIEV) said local data (DL) at the level of said arrival layer (L₇).

5. A method of processing a data unit (UDR) received via a network (R) as claimed in claim 4, characterized in that said method also comprises a marking step (MARK) intended to associate said data structure (SDL) with a received data unit (UDR) by adding a marker (Mk) to it.

6. A transmitter (EM), comprising:
means for using a network stack (PR′) intended to process a data unit (UDR) received via a network (R),
means for establishing a direct connection (CD′) between a departure layer (L′₇) and an arrival layer (L′₁) of said network stack,
means (GENER) for generating local data (DL′) at the level of said departure layer (L′₇), said local data (DL′) being intended to be transmitted to said arrival layer (L′₁) via said direct connection (CD′),
means (PACKET′) for packeting said local data (DL′) into a data structure (SDL′), and
means (RETRIEV′) for retrieving said local data (DL′) at the level of said arrival layer (L′₁).

7. A transmitter (EM) as claimed in claim 6, characterized in that said transmitter also comprises marking means (MARK′) intended to associate said data structure (SDL′) with said data to be transmitted (DE), by adding a marker (M′ₖ) to it.

8. A transmitter (EM) as claimed in claim 7, characterized in that said marker (M′ₖ) is chosen to be equal to said data to be transmitted (DE).

9. A transmission system comprising a transmitter (EM), a network (R) and a receiver (REC) for transmitting a data unit (UDE) from said transmitter to said receiver via said network, said receiver comprising:
means for using a network stack (PR) intended to process a data unit (UDR) received via a network (R),
means for establishing a direct connection (CD) between a departure layer (L₁) and an arrival layer (L₇) of said network stack,
means (GENER) for generating local data (DL) at the level of said departure layer (L₁), said local data (DL) being intended to be transmitted to said arrival layer (L₇) via said direct connection (CD),
means (PACKET) for packeting said local data (DL) into a data structure (SDL), and
means (RETRIEV) for retrieving said local data (DL) at the level of said arrival layer (L₇).

10. A transmission system comprising a transmitter (EM), a network (R) and a receiver (REC) for transmitting data (DE) from said transmitter to said receiver via said network, said transmitter comprising:
means for using a network stack (PR′) intended to transform said data (DE) to be transmitted into a data unit (UDE),
means for establishing a direct connection (CD′) between a departure layer (L′₇) and an arrival layer (L′₁) of said network stack,
means (GENER) for generating local data (DL′) at the level of said departure layer (L′₇), said local data (DL′) being intended to be transmitted to said arrival layer (L′₁) of said direct connection,
means (PACKET′) for packeting said local data (DL′) into a data structure (SDL′), and
means (RETRIEV′) for retrieving said local data (DL′) at the level of said arrival layer (L′₁).

11. A computer program for a receiver (REC), comprising a set of instructions for performing a method as claimed in claim 4, when said program is executed by a processor.
